(19) United States
(12) Patent Application Publication
(10) Pub. No.: US 2026/0321853 A1
(43) Pub. Date: Oct. 15, 2026

(54) BATTERY PACK AND BATTERY CELL RETAINER THEREOF

(71) Applicant: MERRY ELECTRONICS (SHENZHEN) CO., LTD., GUANGDONG (CN)

(72) Inventors: Jia-Xin LIN, Taichung City (TW); Wei-Hao TU, Taichung City (TW); Feng-Ping CHANG, Taichung City (TW)

(21) Appl. No.: 19/292,883

(22) Filed: Aug. 6, 2025

(30) Foreign Application Priority Data
Apr. 11, 2025 (TW) 114113881

(51) Int. Cl. H01M 50/264; H01M 50/213; H01M 50/291

(52) U.S. Cl. CPC H01M 50/264; H01M 50/213; H01M 50/291

(57) ABSTRACT

A battery cell retainer includes a barrier plate, a pillar structure and an interconnection structure. The pillar structure extends substantially perpendicularly to the barrier plate and has a first end and a second end opposite to the first end. The interconnection structure is connected between the pillar structure and the barrier plate. The interconnection structure includes a first arc portion and a second arc portion, both of which have concave shapes. The first arc portion extends from one side of the barrier plate to the first end of the pillar structure, and the second arc portion extends from another side of the barrier plate to the second end of the pillar structure.

### RELATED APPLICATIONS

This application claims priority to Taiwan Application Serial Number 114113881, filed Apr. 11, 2025, the disclosure of which is incorporated herein by reference in its entirety.

### BACKGROUND

### Technical Field

The present disclosure relates to a battery pack and a battery cell retainer thereof.

### Description of Related Art

A battery pack typically includes multiple battery cells. Conventionally, foam is inserted between the battery cells and the casing of the battery pack for positioning and cushioning of the battery cells. However, different models of battery packs have different structures (for example, different models of battery packs may have different shapes or different battery cell configurations). Therefore, when adopting the conventional technique described above, it is required to analyze and determine the size of foam to be used, the amount of glue to be used, the location to place the foam, and the location to apply the glue for each different model of battery pack individually, which is a complicated task.

### SUMMARY

In view of the foregoing, one of the objects of the present disclosure is to provide a battery cell retainer to resolve the problems described above.

In accordance with an embodiment of the present disclosure, a battery cell retainer includes a barrier plate, a pillar structure and an interconnection structure. The pillar structure extends substantially perpendicularly to the barrier plate and has a first end and a second end opposite to the first end. The interconnection structure is connected between the pillar structure and the barrier plate. The interconnection structure includes a first arc portion and a second arc portion, both of which have concave shapes. The first arc portion extends from one side of the barrier plate to the first end of the pillar structure, and the second arc portion extends from another side of the barrier plate to the second end of the pillar structure.

In one or more embodiments of the present disclosure, a contour of at least one of the first arc portion or the second arc portion of the interconnection structure includes a plurality of sections. The sections are connected in order and have different radii of curvature. Any two adjacent sections are tangent to each other.

In one or more embodiments of the present disclosure, each section is a circular arc, and each section has a corresponding angle of no more than 45 degrees.

In one or more embodiments of the present disclosure, the radii of curvature of the sections are increasingly larger in a direction from the barrier plate to the first end of the pillar structure or in a direction from the barrier plate to the second end of the pillar structure.

In one or more embodiments of the present disclosure, the first arc portion and the second arc portion of the interconnection structure are disposed on two opposite sides of the barrier plate and are symmetric with respect to the barrier plate.

In one or more embodiments of the present disclosure, a contour of the barrier plate includes at least one curved section.

In one or more embodiments of the present disclosure, the barrier plate has a shape of an ellipse.

In one or more embodiments of the present disclosure, the barrier plate includes a first wing portion and a second wing portion. The first wing portion and the second wing portion extend curvedly and extend outward from two sides of the interconnection structure, respectively.

In one or more embodiments of the present disclosure, the barrier plate is symmetric with respect to the interconnection structure.

In one or more embodiments of the present disclosure, the first end and the second end of the pillar structure are located on two opposite sides of the barrier plate. The barrier plate includes a rib structure arranged symmetrically on the two opposite sides of the barrier plate.

In accordance with an embodiment of the present disclosure, a battery pack includes a housing, a battery cell, a battery cell retainer and a fastener. The housing includes a main body and an internally threaded post. The main body has an accommodation space. The internally threaded post is disposed on an inner wall of the accommodation space and has a front opening and a groove communicating with the front opening. The battery cell is disposed in the accommodation space of the housing. The battery cell retainer includes a pillar structure, a barrier plate and an interconnection structure. The pillar structure is disposed in the groove and has a first end and a second end opposite to the first end. The barrier plate is located outside the groove and abuts against the battery cell. The interconnection structure is connected between the pillar structure and the barrier plate. The interconnection structure includes a first arc portion and a second arc portion, both of which have concave shapes. The first arc portion extends from one side of the barrier plate to the first end of the pillar structure, and the second arc portion extends from another side of the barrier plate to the second end of the pillar structure. The fastener is fixedly inserted into the groove via the front opening and abuts against the pillar structure of the battery cell retainer.

In sum, the present disclosure provides a battery cell retainer compatible with different models of battery packs to help simplify the task of installing and fixing battery cells. The battery cell retainer of the present disclosure includes a pillar structure that can be inserted into an internally threaded post on an inner wall of the housing of the battery pack, and further includes a barrier plate that can be pressed against the battery cell. After installing the battery cell retainer, simply screw a fastener into the internally threaded post to complete fixing of the battery cell.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates an axonometric view of a battery pack in accordance with an embodiment of the present disclosure;

FIG. 2 illustrates a cross-sectional exploded view of the battery pack shown in FIG. 1;

FIG. 3 illustrates a top view of the battery pack shown in FIG. 1 when a lid of the battery pack is removed;

FIG. 4 illustrates a top view of one of the battery cell retainers shown in FIG. 2;

FIG. 5 illustrates a side view of one of the battery cell retainers shown in FIG. 2;

FIG. 6 illustrates a cross-sectional exploded view of a battery pack in accordance with another embodiment of the present disclosure;

FIG. 7 illustrates a top view of one of the battery cell retainers shown in FIG. 6; and

FIG. 8 illustrates a side view of one of the battery cell retainers shown in FIG. 6.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

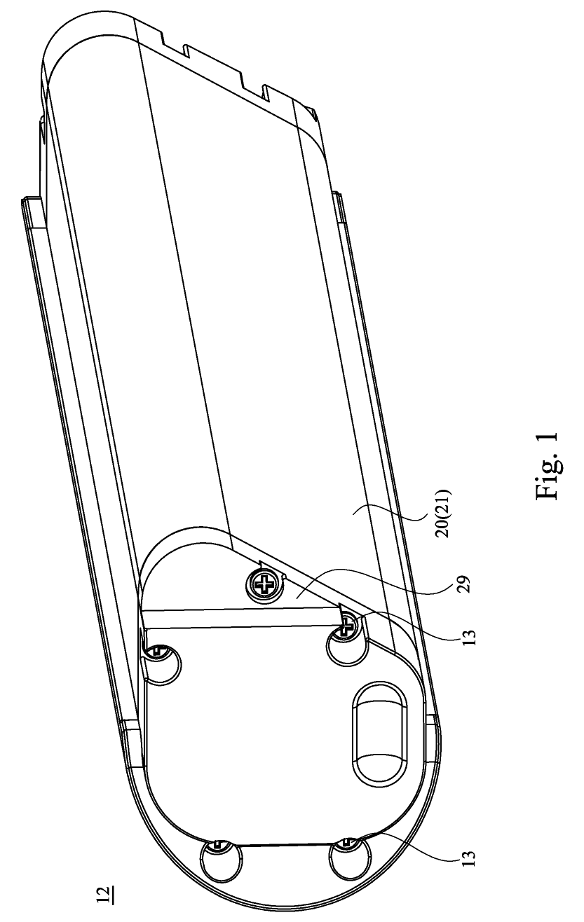

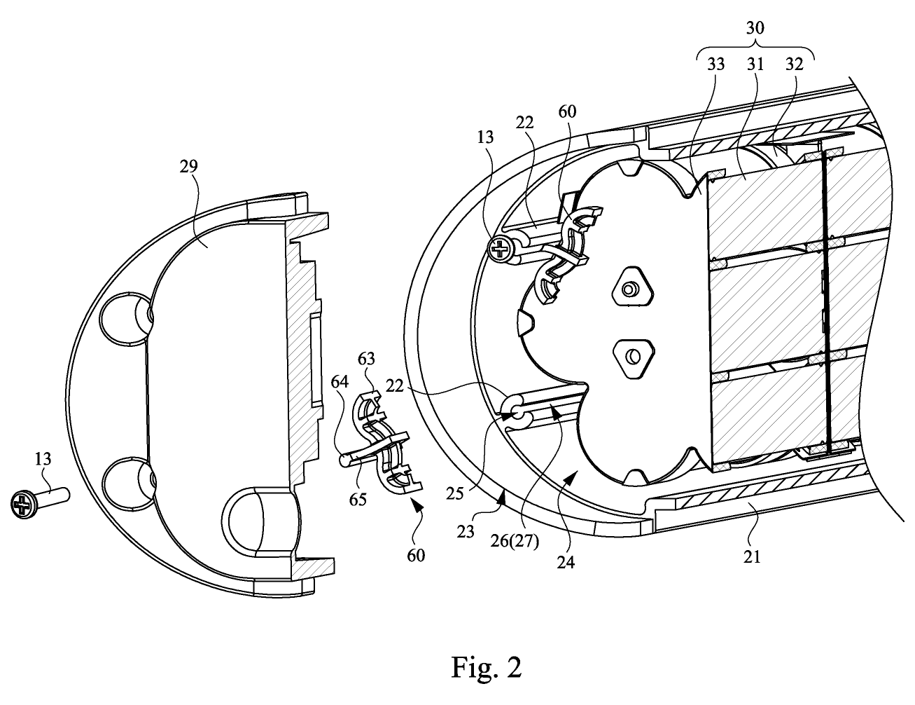

Reference is made to FIGS. 1 and 2. FIG. 1 illustrates an axonometric view of a battery pack 12 in accordance with an embodiment of the present disclosure. FIG. 2 illustrates a cross-sectional exploded view of the battery pack 12 shown in FIG. 1. As shown, the battery pack 12 includes a housing 20 and a lid 29. The housing 20 may include a main body 21 and at least one internally threaded post 22. The main body 21 is, for example, a hollow and generally cylindrical structure. Specifically, the main body 21 has an opening 23 and an accommodation space 24 communicating with the opening 23. The internally threaded post 22 is disposed on an inner wall of the accommodation space 24. For example, the internally threaded post 22 can extend substantially perpendicularly to the opening 23. The lid 29 is configured to cover the opening 23 of the main body 21. In some embodiments, the lid 29 is affixed to the main body 21 by at least one fastener 13 (e.g., at least one screw). The fastener 13 can extend through at least one through hole of the lid 29, and the fastener 13 can be inserted into the internally threaded post 22 and engage with the internal thread of the internally threaded post 22.

As shown in FIGS. 1 and 2, the battery pack 12 further includes at least one battery module 30 disposed in the accommodation space 24 of the main body 21 and including at least one battery cell 31. The internally threaded post 22 is disposed in a gap between the battery cell 31 and the main body 21 of the housing 20. In some embodiments, the housing 20 is a unitary housing formed of aluminum or other suitable materials.

As shown in FIGS. 1 and 2, in some embodiments, the battery module 30 further includes a frame 32 sleeved on the at least one battery cell 31. In some embodiments, the battery module 30 further includes at least one electrode connection sheet (not depicted in the drawings) which can connect the electrodes of multiple battery cells 31 and make the battery cells 31 connected in parallel or in series. In some embodiments, the battery module 30 further includes an insulation sheet 33. The insulation sheet 33 can cover the electrodes of the battery cells 31 and can also cover the electrode connection sheet mentioned above. The insulation sheet 33 can prevent short-circuiting between the battery cell and other electronic component(s), such as a circuit board. The insulation sheet 33 can include Mylar or other suitable electrically insulative material.

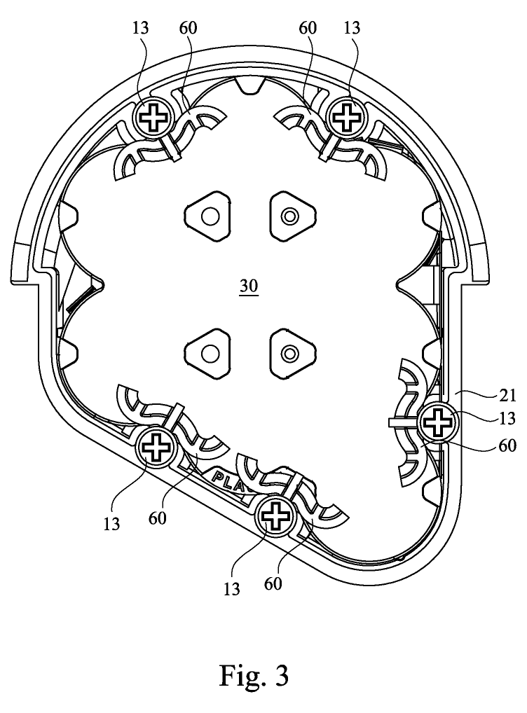

Reference is made additionally to FIG. 3. FIG. 3 illustrates a top view of the battery pack 12 shown in FIG. 1 when the lid 29 of the battery pack 12 is removed. As shown in FIGS. 2 and 3, the battery pack 12 further includes at least one battery cell retainer 60. The battery cell retainer 60 is disposed in the accommodation space 24 of the housing 20 and is configured to hold the battery module 30 (the battery cell 31 in particular) in place in the accommodation space 24.

As shown in FIGS. 2 and 3, each internally threaded post 22 has a front opening 25 and a groove 26. The front opening 25 is located on an end of the internally threaded post 22 facing the opening 23 of the main body 21. The groove 26 communicates with the front opening 25 and can have an internal thread. Each internally threaded post 22 further has a side opening 27. The side opening 27 is located on a side of the internally threaded post 22 facing the battery module 30, and the side opening 27 communicates with the groove 26. Each battery cell retainer 60 includes a barrier plate 63, a pillar structure 64 and an interconnection structure 65. The barrier plate 63 is located outside the groove 26 of the internally threaded post 22, and one surface of the barrier plate 63 abuts against the battery cell 31. The pillar structure 64 is disposed in the groove 26. A maximum width of the pillar structure 64 is greater than a maximum width of the side opening 27 of the internally threaded post 22, and as a result, the pillar structure 64 is prevented from escaping the groove 26. The interconnection structure 65 is connected between the pillar structure 64 and the barrier plate 63, and the interconnection structure 65 extends through the side opening 27 of the internally threaded post 22. The fastener 13 is fixedly inserted into the groove 26 of the internally threaded post 22 via the front opening 25, and the fastener 13 abuts against the pillar structure 64 of the battery cell retainer 60.

By this arrangement, the battery cell 31 can be stably held in place in the accommodation space 24 to prevent displacement of the battery cell 31 in case of external force acting on the battery pack 12. The battery cell retainer 60 is simple to use. After the battery cell 31 is placed into the housing 20, simply insert the pillar structure 64 of the battery cell retainer 60 into the internally threaded post 22 and press the barrier plate 63 of the battery cell retainer 60 against the battery cell 31, and then screw the fastener 13 into the internally threaded post 22 to complete fixing of the battery cell 31. The pillar structure 64 of the battery cell retainer 60 is slidable within the internally threaded post 22 and has adjustable position, and thus the battery cell retainer 60 is compatible with different models of battery packs 12. Accordingly, the battery cell retainer 60 of the present disclosure can help simplify the task of installing and fixing battery cells 31.

It is noted that the expression “element X abuts against element Y” used herein can mean that element X makes contact with and presses against element Y, or that element X presses against element Y via other element(s) without contacting element Y.

As shown in FIGS. 2 and 3, in some embodiments, the housing 20 includes a plurality of internally threaded posts 22 arranged around the battery module 30. Correspondingly, the battery pack 12 includes a plurality of fasteners 13 and a plurality of battery cell retainers 60. Each the battery cell retainers 60 is inserted into the groove 26 of a corresponding one of the internally threaded posts 22, and each of the fasteners 13 is inserted into the groove 26 of a corresponding one of the internally threaded posts 22.

In some embodiments, the battery cell retainer 60 can include metal material, such that the battery cell retainer 60 can have improved strength. In such embodiments, an insulating tape can be provided between the battery cell retainer 60 and the battery module 30 to enhance electrical insulation between the battery cell retainer 60 and the battery module 30.

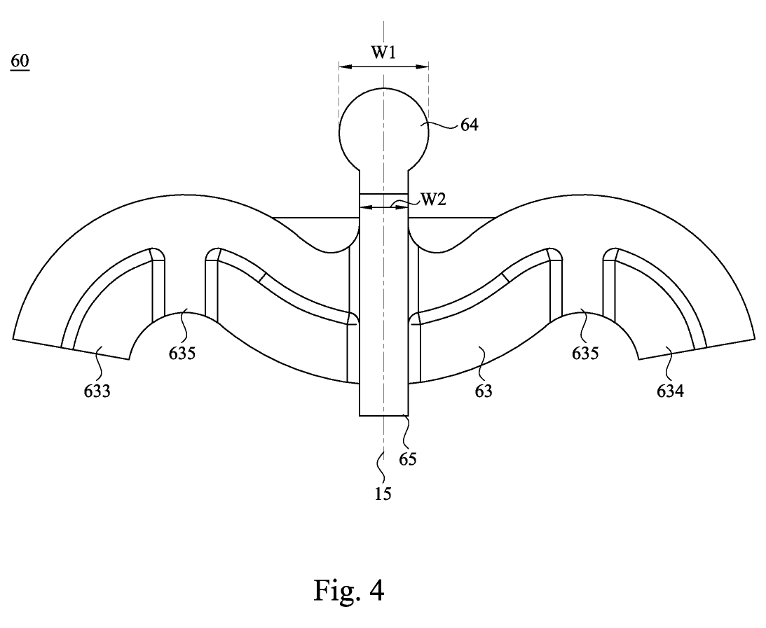

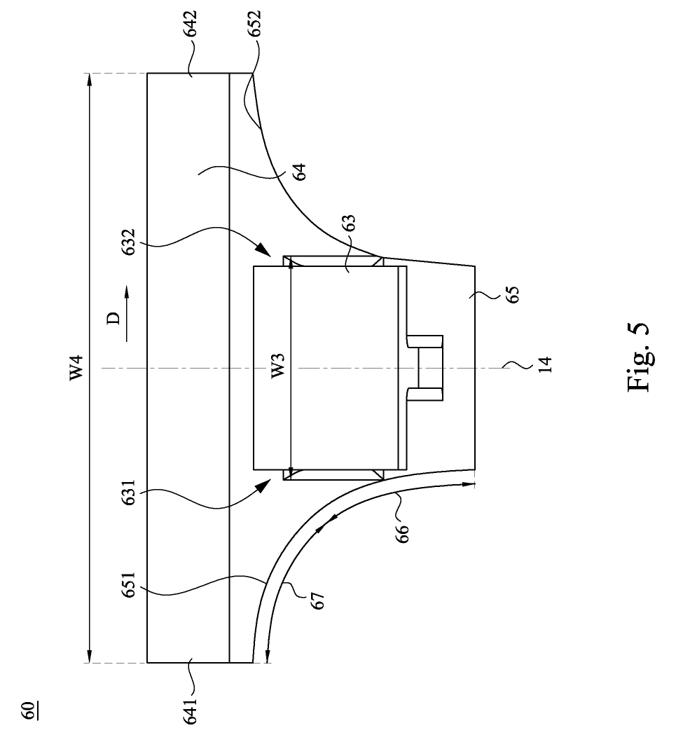

Reference is made to FIGS. 4 and 5. FIG. 4 illustrates a top view of one of the battery cell retainers 60 shown in FIG. 2. FIG. 5 illustrates a side view of one of the battery cell retainers 60 shown in FIG. 2. As mentioned above, the battery cell retainer 60 includes the barrier plate 63, the pillar structure 64 and the interconnection structure 65. The pillar structure 64 is disposed on a side of the barrier plate 63 and extends substantially perpendicularly to the barrier plate 63. The pillar structure 64 can be generally cylindrical, or can have other suitable shapes. The pillar structure 64 has a first end 641 and a second end 642 opposite to the first end 641. The barrier plate 63 has a first side 631 and a second side 632 opposite to the first side 631. The first end 641 and the second end 642 of the pillar structure 64 are located on the first side 631 and the second side 632 of the barrier plate 63, respectively. The interconnection structure 65 includes a first arc portion 651 and a second arc portion 652, both of which have concave shapes. The first arc portion 651 extends from the first side 631 of the barrier plate 63 to the first end 641 of the pillar structure 64, and the second arc portion 652 extends from the second side 632 of the barrier plate 63 to the second end 642 of the pillar structure 64.

As shown in FIGS. 4 and 5, in some embodiments, a contour of the first arc portion 651 of the interconnection structure 65 of the battery cell retainer 60 includes a plurality of sections connected in order. Each section can be a circular arc. In other words, the contour of the first arc portion 651 includes a plurality of circular arcs connected in order. The circular arcs (i.e., the sections) can have different radii of curvature. Any two adjacent sections are tangent to each other. In the illustrated embodiment, the contour of the first arc portion 651 includes two sections 66 and 67 connected to each other. The two sections 66 and 67 have different radii of curvature and are tangent to each other. By this arrangement, when the battery pack 12 experiences impact of external force, the battery cell retainer 60 can effectively spread out stress to prevent rupturing of the battery cell retainer 60.

As shown in FIGS. 4 and 5, in some embodiments, the contour of the first arc portion 651 corresponds to a range of ninety degrees, and each section has a corresponding angle of no more than 45 degrees. In the illustrated embodiment, the contour of the first arc portion 651 includes two sections 66 and 67 each having a corresponding angle of 45 degrees. In other embodiments, the contour of the first arc portion 651 can include three or more sections.

As shown in FIGS. 4 and 5, in some embodiments, a contour of the second arc portion 652 of the interconnection structure 65 also includes a plurality of sections. The sections of the contour of the second arc portion 652 can have structural configurations identical or similar to the structural configurations of the sections of the contour of the first arc portion 651 described above, and for the sake of brevity, these structural configurations are not repeated here.

As shown in FIGS. 4 and 5, in some embodiments, the radii of curvature of the sections of the first arc portion 651 are increasingly larger in a direction from the barrier plate 63 to the first end 641 of the pillar structure 64. In the illustrated embodiment, the radius of curvature of the section 67 is greater than the radius of curvature of the section 66. Likewise, the radii of curvature of the sections of the second arc portion 652 are increasingly larger in a direction from the barrier plate 63 to the second end 642 of the pillar structure 64.

As shown in FIGS. 4 and 5, in some embodiments, the first arc portion 651 and the second arc portion 652 of the interconnection structure 65 of the battery cell retainer 60 are disposed on the first side 631 and the second side 632 of the barrier plate 63, respectively, and are symmetric with respect to the barrier plate 63. A plane 14 passing through the center of the barrier plate 63 may act as the plane of symmetry for the first arc portion 651 and the second arc portion 652. Said symmetric configuration of the first arc portion 651 and the second arc portion 652 can help strengthen the battery cell retainer 60 and prevent rupturing of the battery cell retainer 60.

As shown in FIGS. 4 and 5, in some embodiments, a contour of the barrier plate 63 includes at least one curved section, which can better avoid stress concentration and prevent rupturing of the battery cell retainer 60 compared to polygonal components. In the present embodiment, the barrier plate 63 has a wave-like shape. Specifically, the barrier plate 63 includes a first wing portion 633 and a second wing portion 634. The first wing portion 633 and the second wing portion 634 extend curvedly and extend outward from two sides of the interconnection structure 65, respectively.

As shown in FIGS. 4 and 5, in some embodiments, the barrier plate 63 is symmetric with respect to the interconnection structure 65. For example, in the present embodiment, the first wing portion 633 and the second wing portion 634 are symmetric to each other. Their plane of symmetry 15 passes through the center of the pillar structure 64 and the center of the interconnection structure 65. Said symmetric configuration of the barrier plate 63 can help strengthen the battery cell retainer 60 and prevent rupturing of the battery cell retainer 60.

As shown in FIGS. 4 and 5, in some embodiments, the barrier plate 63 includes a rib structure 635. The rib structure 635 includes multiple ribs projecting from the surfaces of the barrier plate 63. The rib structure 635 is arranged symmetrically on the first side 631 and the second side 632 of the barrier plate 63. The plane of symmetry for the rib structure 635 is the plane 14 passing through the center of the barrier plate 63. The rib structure 635 can help strengthen the barrier plate 63 to prevent rupturing of the battery cell retainer 60. In some embodiments, each rib of the rib structure 635 has a width of at least 0.6 mm.

As shown in FIGS. 4 and 5, in some embodiments, a width W2 of the interconnection structure 65 is less than a width W1 of the pillar structure 64, such that the interconnection structure 65 can extend through the side opening 27 of the internally threaded post 22 mentioned above and connect with the barrier plate 63. In some embodiments, the width W2 of the interconnection structure 65 is approximately half of the width W1 of the pillar structure 64.

As shown in FIGS. 4 and 5, in some embodiments, in a direction D along which the pillar structure 64 extends (e.g., the axial direction of the pillar structure 64), a width W3 of the barrier plate 63 is greater than or equal to a quarter of a width W4 of the pillar structure 64. By this arrangement, the battery cell retainer 60 can have improved strength and can prevent rupturing of the battery cell retainer 60.

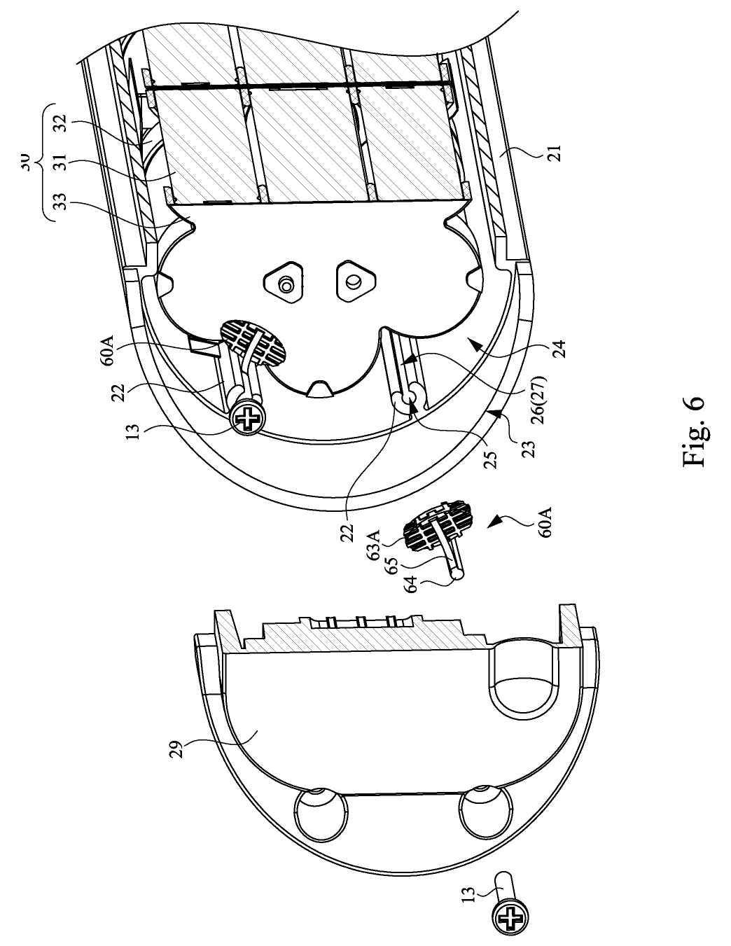

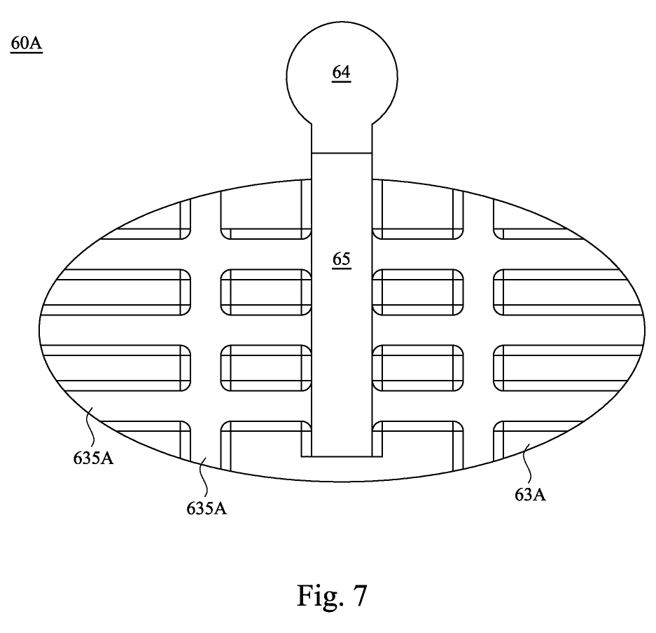

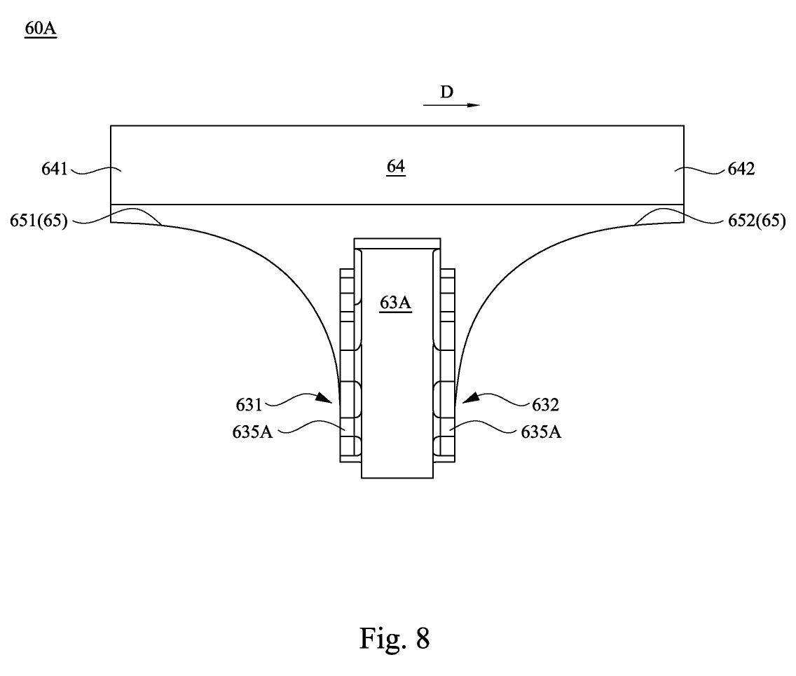

Reference is made to FIGS. 6-8. FIG. 6 illustrates a cross-sectional exploded view of a battery pack in accordance with another embodiment of the present disclosure. FIG. 7 illustrates a top view of one of the battery cell retainers 60A shown in FIG. 6. FIG. 8 illustrates a side view of one of the battery cell retainers 60A shown in FIG. 6. The present embodiment differs from the previous embodiment in that the barrier plate 63A of the battery cell retainer 60A of the present embodiment is structurally different from the barrier plate 63 of the battery cell retainer 60 described above. Specifically, the barrier plate 63A of the battery cell retainer 60A generally has a shape of an ellipse. The major axis of the elliptic barrier plate 63A can extend across two sides of the interconnection structure 65, and the elliptic barrier plate 63A can be symmetric with respect to the interconnection structure 65. Moreover, the rib structure 635A of the barrier plate 63A includes multiple interlaced ribs forming a mesh-like rib structure 635A. Other parts of the battery cell retainer 60A can be configured in a way identical or similar to the aforementioned battery cell retainer 60, the description of which can be found in the preceding paragraphs and are not repeated here.

In sum, the present disclosure provides a battery cell retainer compatible with different models of battery packs to help simplify the task of installing and fixing battery cells. The battery cell retainer of the present disclosure includes a pillar structure that can be inserted into an internally threaded post on an inner wall of the housing of the battery pack, and further includes a barrier plate that can be pressed against the battery cell. After installing the battery cell retainer, simply screw a fastener into the internally threaded post to complete fixing of the battery cell.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A battery cell retainer, comprising:
a barrier plate;
a pillar structure extending substantially perpendicularly to the barrier plate and having a first end and a second end, the second end being opposite to the first end; and
an interconnection structure connected between the pillar structure and the barrier plate, wherein the interconnection structure comprises a first arc portion and a second arc portion, both of which have concave shapes, the first arc portion extends from one side of the barrier plate to the first end of the pillar structure, and the second arc portion extends from another side of the barrier plate to the second end of the pillar structure.

2. The battery cell retainer of claim 1, wherein a contour of at least one of the first arc portion or the second arc portion of the interconnection structure comprises a plurality of sections, the sections are connected in order and have different radii of curvature, and any two adjacent ones of the sections are tangent to each other.

3. The battery cell retainer of claim 2, wherein each of the sections is a circular arc, and each of the sections has a corresponding angle of no more than 45 degrees.

4. The battery cell retainer of claim 2, wherein the radii of curvature of the sections are increasingly larger in a direction from the barrier plate to the first end of the pillar structure or in a direction from the barrier plate to the second end of the pillar structure.

5. The battery cell retainer of claim 1, wherein the first arc portion and the second arc portion of the interconnection structure are disposed on two opposite sides of the barrier plate and are symmetric with respect to the barrier plate.

6. The battery cell retainer of claim 1, wherein a contour of the barrier plate comprises at least one curved section.

7. The battery cell retainer of claim 6, wherein the barrier plate has a shape of an ellipse.

8. The battery cell retainer of claim 6, wherein the barrier plate comprises a first wing portion and a second wing portion, the first wing portion and the second wing portion extend curvedly and extend outward from two sides of the interconnection structure, respectively.

9. The battery cell retainer of claim 1, wherein the barrier plate is symmetric with respect to the interconnection structure.

10. The battery cell retainer of claim 1, wherein the first end and the second end of the pillar structure are located on two opposite sides of the barrier plate, the barrier plate comprises a rib structure arranged symmetrically on the two opposite sides of the barrier plate.

11. A battery pack, comprising:
a housing comprising a main body and an internally threaded post, wherein the main body has an accommodation space, the internally threaded post is disposed on an inner wall of the accommodation space and has a front opening and a groove communicating with the front opening;
a battery cell disposed in the accommodation space of the housing;
a battery cell retainer, comprising:
a pillar structure disposed in the groove and having a first end and a second end, the second end being opposite to the first end;
a barrier plate located outside the groove and abutting against the battery cell; and
an interconnection structure connected between the pillar structure and the barrier plate, wherein the interconnection structure comprises a first arc portion and a second arc portion, both of which have concave shapes, the first arc portion extends from one side of the barrier plate to the first end of the pillar structure, and the second arc portion extends from another side of the barrier plate to the second end of the pillar structure; and
a fastener fixedly inserted into the groove via the front opening and abutting against the pillar structure of the battery cell retainer.

12. The battery pack of claim 11, wherein a contour of at least one of the first arc portion or the second arc portion of the interconnection structure comprises a plurality of sections, the sections are connected in order and have different radii of curvature, and any two adjacent ones of the sections are tangent to each other.

13. The battery pack of claim 12, wherein each of the sections is a circular arc, and each of the sections has a corresponding angle of no more than 45 degrees.

14. The battery pack of claim 12, wherein the radii of curvature of the sections are increasingly larger in a direction from the barrier plate to the first end of the pillar structure or in a direction from the barrier plate to the second end of the pillar structure.

15. The battery pack of claim 11, wherein the first arc portion and the second arc portion of the interconnection structure are disposed on two opposite sides of the barrier plate and are symmetric with respect to the barrier plate.

16. The battery pack of claim 11, wherein a contour of the barrier plate comprises at least one curved section.

17. The battery pack of claim 16, wherein the barrier plate has a shape of an ellipse.

18. The battery pack of claim 16, wherein the barrier plate comprises a first wing portion and a second wing portion, the first wing portion and the second wing portion extend curvedly and extend outward from two sides of the interconnection structure, respectively.

19. The battery pack of claim 11, wherein the barrier plate is symmetric with respect to the interconnection structure.

20. The battery pack of claim 11, wherein the first end and the second end of the pillar structure are located on two opposite sides of the barrier plate, the barrier plate comprises a rib structure arranged symmetrically on the two opposite sides of the barrier plate.
